(19) United States
(12) Patent Application Publication
(10) Pub. No.: US 2018/0056502 A1
(43) Pub. Date: Mar. 1, 2018

(54) ROBOT MOUNTING

(71) Applicant: KUKA Roboter GmbH, Augsburg (DE)

(72) Inventors: Sebastian Lohmeier, Muenchen (DE); Robert Fodor, Augsburg (DE); Cyrill Von Tiesenhausen, Augsburg (DE); Dilyan Marinov, Elin Pelin (BG)

(21) Appl. No.: 15/556,755

(22) PCT Filed: Mar. 10, 2016
(86) PCT No.: PCT/EP2016/000435

§ 371 Date: Sep. 8, 2017

(30) Foreign Application Priority Data
Mar. 11, 2015 (DE) 10 2015 003 136.8

(51) Int. Cl. B25J 9/00; B25J 19/06

(52) U.S. Cl. CPC B25J 9/0009; B25J 19/06

(57) ABSTRACT

A robot bearing according to the invention for the pivotable mounting of a robot has a base (10) and a support (20) mounted thereon for the, in particular releasable, fastening of a foot (30) of the robot, the support being pivotably mounted relative to the base between an operating position and a stowage position.

### CROSS-REFERENCE

This application is a national phase application under 35 U.S.C. § 371 of International Patent Application No. PCT/EP2016/000435, filed Mar. 10, 2016 (pending), which claims the benefit of German Patent Application No. DE 10 2015 003 136.8 filed Mar. 11, 2015, the disclosures of which are incorporated by reference herein in their entirety.

### TECHNICAL FIELD

The present invention relates to a robot mounting for pivotally mounting a robot, a robot assembly with the robot mounting as well as a method for rescuing a person from a workspace of the robot assembly.

### BACKGROUND

In many human-robot cooperation applications the robot is usually stopped by means of brakes in the event of a fault in order to avoid the risk of injuring a person. However, this can lead to entrapment situations in which a person is obstructed, in particular trapped, by the robot that has been stopped.

The published documents U.S. Pat. No. 7,979,157 B2 and DE 10 2012 110 193 A1 disclose robot assemblies with robot mountings, by means of which a multi-axis robot is mounted on horizontal rails of an operating table. As a result, a robot that has been stopped can be moved only linearly or can be completely released from the operating table, so that then the entire weight of said robot has to be supported.

### SUMMARY

One object of an embodiment of the present invention is to improve the rescue of people from a workspace of a robot assembly.

This object is achieved by a robot mounting exhibiting the features disclosed in claim 1. Claims 11, 14 protect a robot assembly with a robot mounting, described herein, and a method for rescuing a person from a workspace of the robot assembly, described herein. The dependent claims relate to advantageous further developments.

According to one aspect of the present invention, a robot mounting for pivotally mounting a robot comprises a single- or multi-part base and a single- or multi-part carrier, which can be attached, in particular is attached, in particular releasably, to a foot of the robot and/or is provided or configured for this purpose, wherein the carrier is pivotally mounted relative to the base between an operating position and a rescue position.

In this way, according to one aspect of the present invention, a person can be rescued from a workspace of the shutdown robot, which comprises at least one closed, in particular mechanical, brake, wherein the carrier is pivoted with the robot foot attached to said carrier out of the operating position into the rescue position while one or more brakes, preferably all of the brakes of the robot are closed.

In one embodiment the carrier can be pivoted manually and/or actuated or is pivoted manually and/or actuated relative to the base between the operating position and the rescue position, wherein the pivoting motion in a further development is (or can be) independent from, or is carried out independently, of a control of the robot. In particular, the actuation is configured to be independent from, or is carried out independently of, a control of the robot. Due to a pivot motion, which is independent of a control of the robot the robot in one embodiment can be advantageously pivoted, even in the event that the robot control fails, into the rescue position by manually pivoting, in particular even in the absence of power.

In one embodiment the robot comprises distally of its foot several, preferably at least six, in particular at least seven, joints or axes, in particular, motor actuated pivot joints or pivot axes. In one embodiment the robot foot and the carrier comprise attachment means, which are intended for, in particular releasably, attaching the robot foot and the carrier to each other and by means of which attachment means in a further development the robot foot and the carrier can be attached, in particular are attached, to each other by means of, for example, screws and complementary bores, undercuts, locking connections or the like.

In one embodiment the robot mounting comprises a single- or multi-part, preferably redundant and/or manually operable locking mechanism, for the, in particular positive locking and/or frictional, locking and/or magnetic, in particular electromagnetic, locking of the carrier in the operating and/or rescue position. In this way it is possible in one embodiment to prevent advantageously an unintentional pivoting of the carrier or the robot.

In a further development the locking mechanism comprises at least two locking parts, which can be moved towards each other in a closing direction and which in a further development have contact surfaces inclined relative to the closing direction, so that a movement or clamping of the contact surfaces in the closing direction towards each other advantageously produces a wedging effect. In a further development the closing direction forms with an axis of rotation of the mounting of the carrier relative to the base a non-zero angle that in a further development is between 45 degrees and 135 degrees and is preferably about 90 degrees. As a result, a closing movement of the locking mechanism can clamp the mounting in a frictional locking manner. In a further development the closing direction is, at least in essence, parallel to an axis of rotation of the mounting of the carrier relative to the base.

In one embodiment one part of the locking mechanism may be formed integrally with the carrier or may be permanently connected thereto or movably mounted thereon. In one embodiment the other part of the locking mechanism may be formed integrally with the base or permanently connected thereto or movably mounted thereon. For example, one part of the locking mechanism may comprise a slidably mounted latching pin; and the other part of the locking mechanism may comprise a corresponding receptacle for the latching pin. In another embodiment the carrier or the base may have an inclined contact surface and, in order to lock in the closing direction, can be slid or clamped against the base or the carrier, and, in so doing, this contact surface presses against the inclined contact surface of the base or the carrier. In one embodiment an axle of a hinge joint may comprise, in particular, may be at the same time a movable part of the locking mechanism.

In one embodiment the robot mounting comprises a single- or multi-part, in particular mechanical and/or pneumatic, biasing means for biasing the carrier into the operating and/or the rescue position. This arrangement allows the movement to be advantageously supported and/or secures the carrier in the operating or rescue position, in particular in addition to the locking mechanism. In a further development the biasing means comprises at least one, in particular mechanical or pneumatic, spring, whose line of force action in the operating and rescue position is on different sides of an axis of rotation of the mounting of the carrier relative to the base, so that the spring upon movement switches between operating and rescue position.

In one embodiment the robot mounting comprises a single- or multi-part, in particular pneumatic and/or hydraulic, shock absorber for damping a movement of the carrier into the operating and/or the rescue position.

In one embodiment the robot mounting comprises one or more hinge joints with an axle and a hub, by means of which hinge joint the carrier is pivotally mounted on the base. In a further development the axle of one or more hinge joints (respectively) is formed integrally with or is permanently connected to the carrier or is mounted in a movable manner, in particular in an axially movable manner, on said carrier; and the hub of this or these hinge joint(s) respectively is formed integrally with or is permanently connected to the base or is mounted in a movable manner, in particular in an axially movable manner, on said base. In another embodiment the hub of one or more hinges (respectively) is formed integrally with or is permanently connected to the carrier or is mounted in a movable manner, in particular in an axially movable manner, on said carrier; and the axle of this or these hinge joints(s) respectively is formed integrally with or is permanently connected to the base or is mounted in a movable manner, in particular in an axially movable manner, on said base.

In one embodiment the axle of the hinge joint is disposed in a radially displaceable manner in a groove. As a result, in a further development said axle can be moved or clamped, in addition to a pivotal movement, in the radial direction, in particular to release or close a locking mechanism. In one embodiment the groove is inclined relative to the direction of closing of the locking mechanism.

In one embodiment an axle, in particular an axially movable pivot pin, of a hinge joint has a conically or frustoconically designed outer surface, which can thus form the contact surface, in particular the contact surface which is inclined relative to the closing direction, of a part of a locking mechanism, which can be moved in a closing direction. In addition or as an alternative, in one embodiment an axle, in particular an axially movable pivot pin, of a hinge joint has a cylindrical outer surface.

In one embodiment the robot mounting comprises one or more link arms, in particular ones which are hinged together, wherein at least one link arm is connected in an articulated manner to the carrier and is connected to the base directly or by means of one or more additional link arms. In a further development the carrier is pivotally mounted on the base by means of one or more, in particular parallel, four bar linkages. In a further development one or more of the four bar linkages are designed to be flat or are formed in order to move their joint points in a plane or to each form a planar mechanism, wherein in one embodiment these planes are then parallel to each other.

In one embodiment the base comprises a linear guide, in particular one which is actuated by motor drive. Thus, in addition to pivoting, the base can be moved linearly. In addition or as an alternative, the base in one embodiment comprises a mounting for attaching, in particular releasably, to an opposite mounting of the robot assembly. In a further development the base, in particular a guide of a linear guide of the base, can be attached, in particular is attached, so as to be fixed with respect to the surrounding area, in particular to the floor, the wall or the ceiling or to a movable frame, in particular an operating table or a, in particular movable, cart, wherein in a further development the movable frame, in particular the operating table or cart, can be connected, in particular is connected, in a non-positive and/or positive locking manner and/or releasably, to a surrounding area, in particular a surrounding-fixed anchoring, or a mobile element. Thus, in one embodiment the base can be attached or is attached to a, in particular passive or actuated, movable trolley, which, in a further development, in turn can be releasably connected, in particular can be or will be connected, to an operating table or a, in particular floor-sided, wall-sided, or ceiling sided, anchoring.

In one embodiment the foot of the robot is arranged at least partially below a surface of the carrier that faces away from the base. In this way the robot can be mounted advantageously in a more compact way.

In one embodiment the carrier comprises one or more wedge-like bearing surfaces, which in the operating position make contact with corresponding wedge-like opposite bearing surfaces of the base in a form-fitting manner, in particular engage in said opposite bearing surfaces, in particular at least substantially in the direction of gravity. In addition or as an alternative, in one embodiment the base comprises one or more wedge-like bearing surfaces, which in the operating position make contact with corresponding wedge-like opposite bearing surfaces of the carrier in a form-fitting manner, in particular engage in these opposite bearing surfaces, in particular at least substantially opposite to the direction of gravity. The movable frame, in particular the cart, to which in one embodiment the base is attached, can be, in particular, the mobile base of a medical robot system according to the parallel proprietary German patent application, which was filed by the applicant on the same day and which relates to a medical robot system, the robot can accordingly be the robot arm of the medical robot system. Correspondingly, reference is also made to this parallel proprietary German patent application, the content of which is explicitly incorporated by reference in its entirety into the present disclosure.

### BRIEF DESCRIPTION OF THE DRAWINGS

Other advantages and features will become apparent from the description of the exemplary embodiments. For this purpose the drawings show, to some extent in schematic form:

FIG. 1: a portion of a robot assembly with a robot mounting according to one embodiment of the present invention;

FIG. 2: a portion of a robot assembly with a robot mounting according to another embodiment of the present invention;

FIG. 3: a portion of a robot assembly with a robot mounting according to another embodiment of the present invention;

FIG. 4: a portion of a robot assembly with a robot mounting according to another embodiment of the present invention; and

FIG. 5: a portion of a robot assembly with a robot mounting according to another embodiment of the present invention.

### DETAILED DESCRIPTION

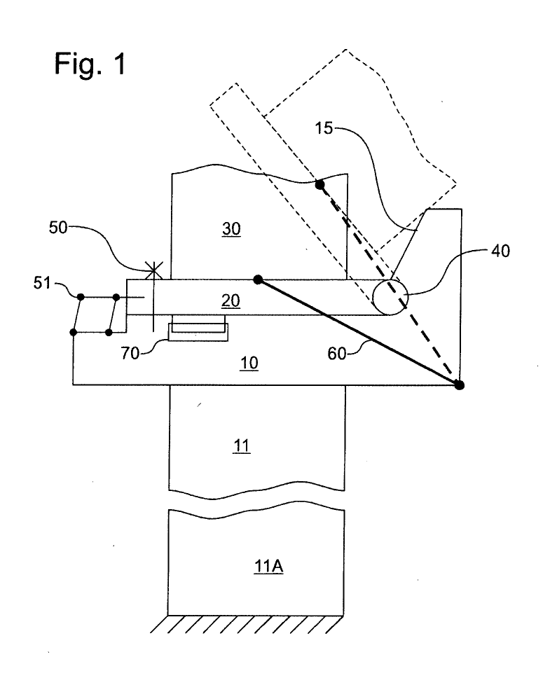

FIG. 1 shows a portion of a robot assembly with a robot mounting according to one embodiment of the present invention.

The robot mounting comprises a base 10 with a linear guide 11, of which only one portion is shown, and a carrier 20, to which a foot of a six- or multi-axis robot 30, which is not illustrated, is releasably attached.

A guide 11A of the linear guide 11 is attached so as to be fixed with respect to the surrounding area, in particular to the floor, the wall or the ceiling or to a movable frame, in particular an operating table or a/an (equipment) cart (not shown).

The carrier 20 is pivotally mounted by means of two aligned hinge joints 40 relative to the base 10 between an operating position, indicated by a solid line in FIG. 1, and a rescue position, indicated by a dashed line in FIG. 1.

In the rescue position a base-fixed stop 15 limits further movement of the carrier with robot (foot) beyond the rescue position. In addition, a complementary abutment can be used in the rescue position, in order to prevent in a form-fitting manner a back pivoting into the operating position (not shown).

In FIG. 1 two locking mechanisms for locking the carrier 20 to the base in the operating position are shown as an example. In one variant the locking mechanism comprises screws 50, which extend through the carrier 20 and engage in complementary bores in the base 10. In one variant, which is also shown in FIG. 1 for the sake of a more compact representation, the locking mechanism comprises a four bar linkage 51, which clamps the carrier 20 not only radially to the axis of rotation of the hinge joints 40, but also perpendicular thereto onto the base 10 and for this purpose engages in a form fitting manner in the carrier 20. In another variant (not shown) of the locking mechanism, this locking mechanism can also comprise, for example, a bayonet closure, solenoids, mechanically switchable magnets, which are known from magnetic chucks, or the like.

The robot mounting comprises a shock absorber 70 for damping a movement of the carrier 20 into the operating position and a mechanical biasing means in the form of two parallel tension or gas springs 60 for biasing the carrier 20 into the operating position and the rescue position. It can be seen from the dotted representation that the springs 60 change suddenly when pivoted into the rescue position and then bias the carrier into this position.

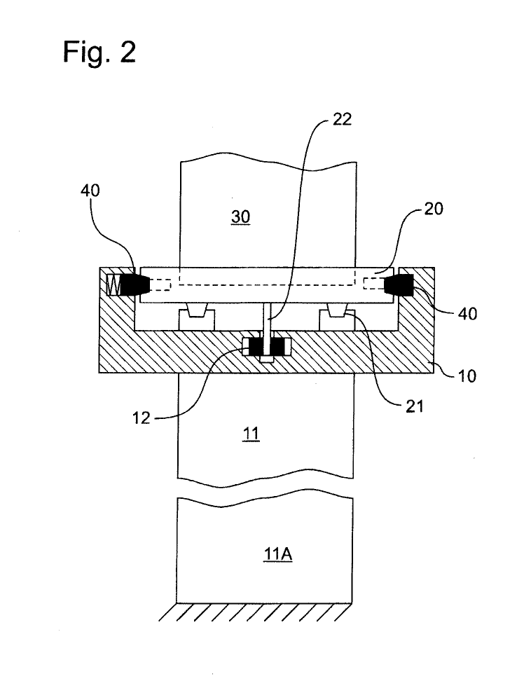

FIG. 2 shows a portion of a robot assembly with a robot mounting according to another embodiment of the present invention. Corresponding features are identified by identical reference signs, so that reference is made to the rest of the description, and only the differences will be discussed below.

In the embodiment in FIG. 2, the carrier 20 has wedge-like bearing surfaces 21, which engage in the direction of gravity (from top to bottom in FIG. 2) in corresponding wedge-like opposite bearing surfaces of the base 10 and make contact with said opposite bearing surfaces in a form fitting manner.

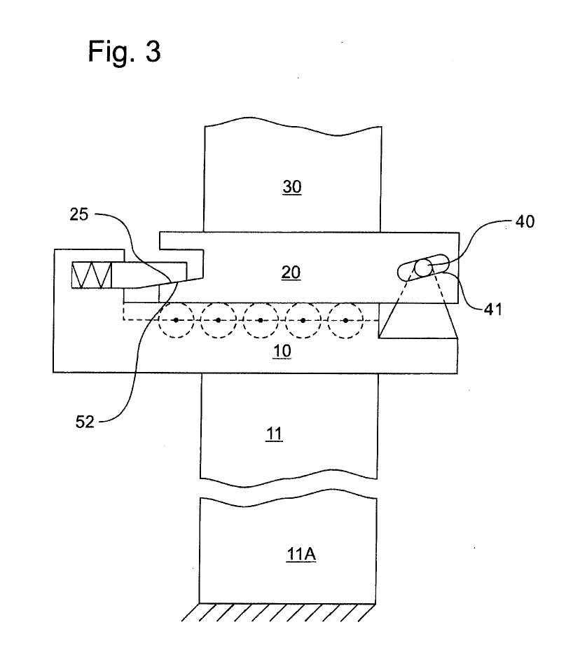

By means of the wedge-like bearing surface 21 the carrier 20 can be fixed advantageously to the base 10 by means of a component of a clamping force that is directed downwards in FIG. 2. For this purpose the carrier 20 can be mounted advantageously in a floating manner by means of two pivot pins, which are shown in solid black in FIG. 2, in order to achieve a statically determined mounting. This concept can be applied directly to the exemplary embodiments which are explained in more detail below with reference to FIG. 3 to FIG. 5.

In addition, the carrier 20 also comprises a fin 22, which can be locked in a frictional locking manner by means of base-fixed jaws 12.

An axle or, more specifically, a pivot pin (shown in solid black in FIG. 2), of the hinge joint 40, shown on the left in FIG. 2, is axially movable and is biased by means of a spring. The axle, which is thus movably mounted in a closing direction (from left to right in FIG. 2), has a rotationally symmetrical contact surface, which is inclined relative to the closing direction and which engages in a frustoconical bore in the carrier 20. Therefore, in addition or as an alternative to the fin 22, the carrier 20 can be locked in a frictional locking manner by clamping in the closing direction.

In the embodiment in FIG. 2 the foot of the robot 30 is disposed partially below a surface (the top in FIG. 2) of the carrier 20, where said surface faces away from the base.

In a first modification (not shown) of the embodiment in FIG. 2, which corresponds, except for the differences explained below, to the embodiment in FIG. 2, the axles or, more specifically, the pivot pins (which are indicated in solid black in FIG. 2) of the hinge joints 40, are designed not only, as shown, frustoconical or conical in shape, but also both of them are slidably mounted relative to the base 10 in the axial direction. The carrier 20 can be advantageously clamped by clamping these two pins 40 in the axial direction.

In order to obtain a component of the clamping force that is directed downwards in FIG. 2 and that advantageously fixes the carrier 20 to the base 10 by means of the wedge-like bearing surface 21, in the operating position the frustoconical or conical bores in the carrier 20 in the first modification can be offset upwards or radially away from the opposite bearing surfaces with respect to the axis of rotation, defined by the two pivot pins of the hinge joints 40 in FIG. 2, so that the pivot pins, engaging in the bores, of the two hinge joints 40, press the wedge-like bearing surface 21 of the carrier 20 into the opposite bearing surfaces of the base 10.

In a second modification (also not shown) of the embodiment in FIG. 2, which corresponds, except for the differences explained below, to the embodiment in FIG. 2 or to the first modification, the bearing surface 21 of the carrier 20 is not wedge shaped, but rather designed to be flat, in particular to fix the carrier 20 advantageously without constraint.

In a third modification (also not shown) of the embodiment in FIG. 2, which corresponds, except for the differences explained below, to the embodiment in FIG. 2 or to the first or second modification, the two pivot pins of the two hinge joints 40 are not designed so as to be frustoconical or conical, but rather cylindrical, so that the carrier 20 is mounted floatingly. The pivot pins 40 and the corresponding bores in the carrier 20 can advantageously form a clearance fit in order to clamp the carrier 20 in the bearing surfaces 21. As an alternative, the carrier 20 may also have oblong holes as the abutment surfaces to the pivot pins of the hinge joints 40.

In one modification (indicated by the dashed line in FIG. 2), which corresponds, except for the differences explained below, to the embodiment in FIG. 2 or to the first, second or third modification, each of the pivot pins has, in addition to the conical outer surfaces or, more specifically, the contact surfaces, an offset with a cylindrical outer surface. As a result, the stability of the mounting can advantageously be improved. In addition or as an alternative, the conical outer surface or, more specifically, the contact surface advantageously assumes in essence only a clamping function.

For the sake of a more compact representation FIG. 2 shows the conical pivot pins of the hinge joints 40 in combination with the fin 22, which can be locked by means of jaws 12. In (additional) modifications of the embodiment in FIG. 2 or the above described first, second or third modification, it is possible, on the one hand, to dispense with fin 22 and jaws 12; or, on the other hand, both pivot pins of both hinge joints 40 and the corresponding bores in the carrier 20 need not be designed in a frustoconical or conical shape, but rather in a cylindrical shape.

In connection with conical pivot pins 40 the two jaws 12 in one embodiment can be floatingly mounted in a direction perpendicular to the side surfaces of the fin 22, in order to prevent in an advantageous manner a clamping of the parts.

For this purpose the jaws 12 in a further development may generate a clamping force, which in FIG. 2 acts at least in essence downwards, in order to clamp the carrier 20 with the bearing surfaces 21 or to generate a clamping force (horizontal in FIG. 2), which acts at least in essence perpendicularly on the lateral contact surfaces of the fin 22, if the axial position of the carrier 20 is defined by a clamping of the conical pivot pin 40. In this case the bearing surfaces 21 are advantageously clamped by the weight of the robot 30.

FIG. 3 shows a portion of a robot assembly with a robot mounting according to another embodiment of the present invention. Corresponding features are identified by identical reference signs, so that reference is made to the rest of the description, and only the differences are discussed below.

In the embodiment of FIG. 3 the axles of the hinge joints 40 are mounted so as to be radially displaceable in grooves 41.

In addition, the locking mechanism shown in the embodiment in FIG. 3 comprises a latching pin which is movably mounted in the closing direction (from left to right in FIG. 2) and biased by a spring and which has a contact surface 52, which is inclined relative to the closing direction, and a complementary contact surface 25, which is integrally formed in the carrier 20, wherein the grooves 41 are inclined relative to the closing direction.

Thus, an axial force of the contact surface 52 clamps the carrier 20 in FIG. 2 vertically on the base 10 and horizontally or radially against the axles of the hinge joints 40 in the inclined grooves 41 and so locks the carrier 20 on the base 10.

As indicated by the dashed lines, in particular, in FIG. 3, in one embodiment the carrier 20 can generally be slidably mounted in the operating position at, in particular on, the base 10 by means of rotatably mounted rolling bodies, in particular rollers, which may define a support between the carrier and the base in the operating position. This arrangement can reduce friction in an advantageous way and, in so doing, further improve in particular the above described locking mechanism. The rolling bodies may in particular be rotatably mounted on the base as indicated by the dashed lines, and may make contact with the carrier in the operating position, or conversely may be rotatably mounted on the carrier and may make contact with the base in the operating position.

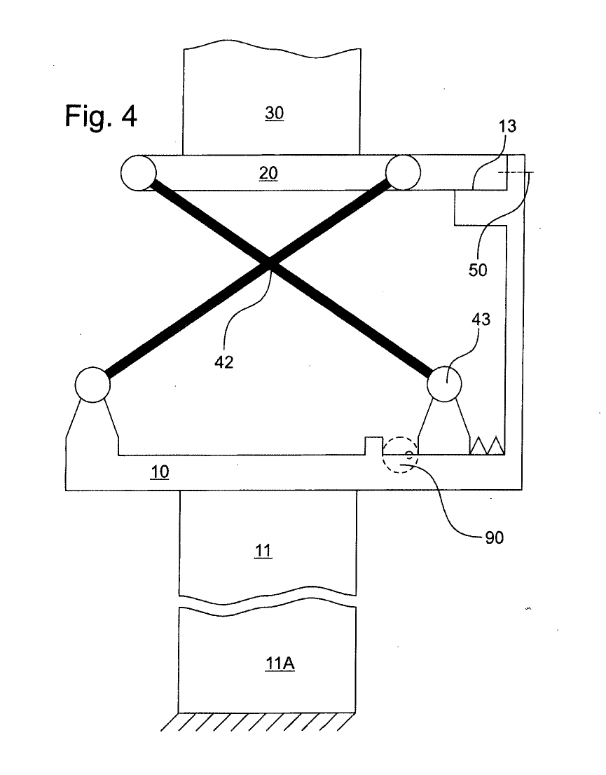

FIG. 4 shows a portion of a robot assembly with a robot mounting according to another embodiment of the present invention. Corresponding features are identified by identical reference signs, so that reference is made to the rest of the description, and only the differences are discussed below.

In the embodiment of FIG. 4 the carrier 20 is pivotally mounted on the base 10 by means of two parallel four bar linkages 42. The base-sided pivot joints 43 (shown on the right side in FIG. 4) of the four bar linkages 42 are clamped by springs. This arrangement clamps the carrier 20, which is pivotally mounted by means of the four bar linkages 42, to a base-sided support 13 and, in so doing, locks the carrier 20 in the operating position shown. In addition, the carrier can be locked in a form fitting manner by means of a pin 50 in said operating position.

This clamping can be released by means of an eccentric 90. Optionally after the pin 50 has been pulled out, the carrier 20 can then be pivoted against the base 10 into a rescue position. In this rescue position the carrier can also be locked (not shown) by means of a biasing means, a lock or the like.

In one modification (not shown) the four bar linkages 42 or the pivot joints 43 thereof can also be clamped by means of the eccentric 90 instead of the spring. To this end the eccentric 90 in the modification may be disposed on the side of the bearing element 43, shown on the right side in FIG. 4. This arrangement makes it possible to save components and/or to increase the stiffness in an advantageous way.

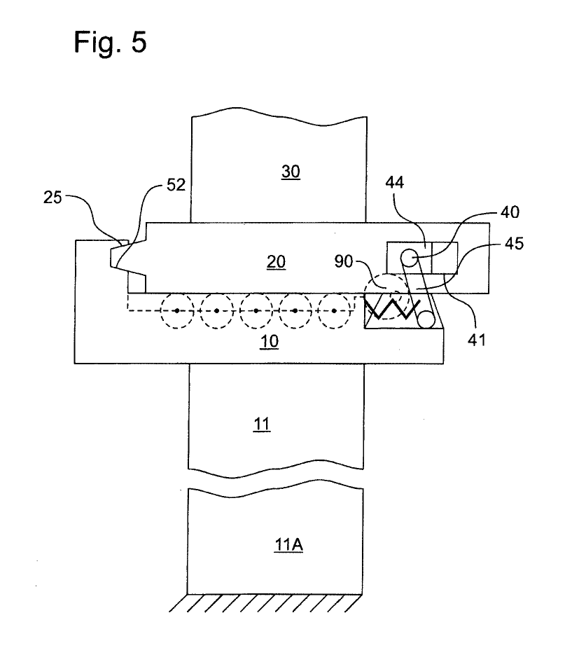

FIG. 5 shows a portion of a robot assembly with a robot mounting according to another embodiment of the present invention. Corresponding features are identified by identical reference signs, so that reference is made to the rest of the description, and only the differences are discussed below.

In the embodiment of FIG. 5 the axes of the hinge joints 40 are mounted, on the one hand, in sliding blocks 44, which in turn are guided in a radially slidable manner in grooves 41 in the carrier 20. In addition, the axles of the hinge joints 40 are connected in an articulated manner to the base 10 by means of one link arm 45 each.

The link arms 45 are clamped by springs and, in so doing, brace a carrier-sided contact surface 25 against a complementary base-sided contact surface 52.

This clamping can be released by means of an eccentric 90. Then the carrier 20 can first be pushed from left to right in FIG. 5, so that the contact surfaces 25, 52, which are inclined relative to a horizontal closing direction, move away from each other. Then the carrier 20 can be pivoted against the base 10 into a rescue position. In this rescue position the carrier can also be locked (not shown) by means of a biasing means, a lock or the like.

As explained with reference to FIG. 3 and also indicated by dashed lines in FIG. 5, the carrier 20 can be slidably mounted at, in particular on, the base 10 by means of rolling bodies, in particular rollers, in the operating position, shown in an embodiment in FIG. 5. This arrangement can reduce friction in an advantageous way and, in so doing, further improve in particular the above described locking mechanism.

In a modification (not shown) the link arms can also be clamped by means of the eccentric 90, as explained above with reference to FIG. 4, instead of the spring. To this end in the modification the eccentric 90 may be disposed on the side (shown on the right side in FIG. 5) of the link arms 45.

In order to rescue a person from a workspace of a robot assembly shown herein, the carrier 20 is pivoted out of the operating position into the rescue position while at least one brake of the robot is closed.

Although exemplary embodiments have been explained in the foregoing description, it should be noted that a variety of modifications are possible. In addition, it should be noted that the exemplary embodiments are only examples that are not intended to restrict in any way the scope, the applications or the configuration. Rather, the foregoing description gives the person skilled in the art a guide for the implementation of at least one exemplary embodiment, whereby various changes, in particular with respect to the function and arrangement of the components described, may be made without departing from the scope, which becomes apparent from the claims and the combinations of features equivalent thereto.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE NUMERALS

10 base

11 linear guide

11 A guide

12 jaw

13 support

15 stop

20 carrier

21 bearing surface

22 fin

25 contact surface

30 robot foot

40 hinge joint (axle)/pivot pin

41 groove

42 four bar linkage

43 pivot joint

44 sliding block

45 link arm

50 screw/pin

51 four bar linkage

52 contact surface

1-14. (canceled)

15. A robot mounting for pivotally mounting a robot, the robot mounting comprising:
a base;
a carrier mounted to the base for mounting a foot of the robot;
wherein the carrier is pivotally mounted relative to the base between an operating position and a rescue position; and
a shock absorber operable to damp a movement of the carrier into at least one of the operating position or the rescue position.

16. The robot mounting of claim 35, wherein the foot of the robot is releasably mounted to the carrier.

17. The robot mounting of claim 35, further comprising a locking mechanism for locking the carrier in at least one of the operating position or the rescue position.

18. The robot mounting of claim 17, wherein the locking mechanism locks the carrier by at least one of positive locking, frictional locking, magnetic locking, or electromagnetic locking.

19. The robot mounting of claim 17, wherein the locking mechanism comprises two locking parts that are movable toward each other in a closing direction, and which have contact surfaces inclined relative to the closing direction.

20. The robot mounting of claim 35, further comprising a biasing means for biasing the carrier into at least one of the operating position or the rescue position.

21. The robot mounting of claim 20, wherein the biasing means is a mechanical biasing means.

22. (canceled)

23. The robot mounting of claim 35, further comprising at least one hinge joint having an axle and a hub, by which the carrier is pivotally mounted on the base.

24. The robot mounting of claim 23, wherein the axle of the hinge joint is mounted so as to be at least one of axially movable or radially displaceable in a groove.

25. The robot mounting of claim 35, further comprising at least one link arm connected in an articulated manner to the carrier and the base.

26. The robot mounting of claim 25, wherein the carrier is pivotally mounted on the base by at least one four bar linkage.

27. The robot mounting of claim 35, wherein the base comprises at least one of a linear guide or a mounting bracket for attaching to a corresponding mounting bracket of the robot.

28. The robot mounting of claim 27, wherein the mounting bracket releasably attaches to the corresponding mounting bracket of the robot.

29. A robot assembly, comprising:
a multi-axis robot having a foot; and
a robot mounting as set forth in claim 35;
wherein the foot of the multi-axis robot is attachable to the carrier of the robot mounting.

30. The robot assembly of claim 29, wherein the foot of the multi-axis robot is releasably attachable to the carrier of the robot mounting.

31. The robot assembly of claim 29, wherein the base is attached so as to be fixed with respect to the surrounding area, or is attached to a movable frame.

32. The robot assembly of claim 31, wherein:
the base is attached so as to be fixed with respect to at least one of the floor, the wall, or the ceiling; or
the movable frame is an operating table or cart.

33. The robot assembly of claim 29, wherein the foot of the robot is disposed at least partially below a surface of the carrier that faces away from the base.

34. A method of rescuing a person from a workspace of a robot assembly, the robot assembly comprising a multi-axis robot having a foot, and a robot mounting for pivotally mounting a robot, the robot mounting comprising a base, a carrier mounted to the base for mounting the foot of the robot, wherein the carrier is pivotally mounted relative to the base between an operating position and a rescue position, the method comprising:
pivoting the carrier out of the operating position into the rescue position while at least one brake of the robot is closed.

35. A robot mounting for pivotally mounting a robot, the robot mounting comprising:
a base;
a carrier mounted to the base for mounting a foot of the robot;
wherein the carrier is pivotally mounted relative to the base between an operating position and a rescue position; and
at least one of:
a shock absorber for damping a movement of the carrier into at least one of the operating position or the rescue position, or
at least one link arm connected in an articulated manner to the carrier and the base.

36. The method of claim 34, further comprising:
releasably mounting the foot of the robot to the carrier.

37. The method of claim 34, further comprising locking the carrier in at least one of the operating position or the rescue position.

38. The method of claim 34, further comprising biasing the carrier into at least one of the operating position or the rescue position.

39. The method of claim 34, further comprising damping a movement of the carrier into at least one of the operating position or the rescue position.

40. The method of claim 34, further comprising connecting at least one link arm in an articulated manner to the carrier and the base.

41. The method of claim 34, further comprising attaching the robot mounting to a corresponding mounting bracket by at least one of a linear guide or a mounting bracket.

42. The method of claim 34, further comprising releasably attaching the foot of the multi-axis robot to the carrier of the robot mounting.

43. The method of claim 34, further comprising attaching the base so as to be fixed with respect to the surrounding area, or attaching the base to a movable frame.
